(19) United States
(12) Patent Application Publication
(10) Pub. No.: US 2023/0062344 A1
(43) Pub. Date: Mar. 2, 2023

(54) VEHICLE CONTROL DEVICE

(71) Applicant: TOYOTA JIDOSHA KABUSHIKI KAISHA, Aichi-ken (JP)

(72) Inventor: Hirotaka SASAKI, Nagoya-shi (JP)

(21) Appl. No.: 17/891,079

(22) Filed: Aug. 18, 2022

(30) Foreign Application Priority Data
Aug. 31, 2021 (JP) 2021-141916

(51) Int. Cl. B60W 20/13; B60W 20/12

(52) U.S. Cl. CPC B60W 20/13; B60W 20/12; B60W 2510/244; B60W 2520/04; B60W 2556/10

(57) ABSTRACT

Provided is a frequency determination unit that determines whether a prohibition frequency at which a drive source control unit prohibits a vehicle from being put in an EV priority mode is equal to or higher than a second threshold value when the vehicle has traveled between a predetermined location and a destination in the past in a state in which a specific target SOC is set to a value lower than a EV-SW permission SOC. When the frequency determination unit determines that the prohibition frequency is equal to or higher than the second threshold value and when the vehicle travels between the predetermined location and the destination, a low SOC control unit adjusts at least one of the specific target SOC and the EV-SW permission SOC such that the specific target SOC becomes a value that is equal to or higher than the EV-SW permission SOC.

### CROSS-REFERENCE TO RELATED APPLICATION

This application claims priority to Japanese Patent Application No. 2021-141916 filed on Aug. 31, 2021, incorporated herein by reference in its entirety.

### BACKGROUND

### 1. Technical Field

The present disclosure relates to a vehicle control device.

### 2. Description of Related Art

The following Japanese Unexamined Patent Application Publication No. 2019-055607 (JP 2019-055607 A) discloses a hybrid electric vehicle (hereinafter referred to as a vehicle) capable of executing a low SOC control that lowers a state of charge (SOC) of the vehicle from a normal value when a predetermined condition is satisfied. This vehicle recognizes how often a forced charge control was executed when the vehicle traveled from a predetermined location to a destination in the past, based on a travel history of the vehicle. The forced charge control is a control for forcibly operating an internal combustion engine in order to increase the SOC of the battery.

When it is determined that an execution frequency of the forced charge control is low, the vehicle executes the low SOC control when the vehicle travels between the predetermined location and the destination. When the low SOC control is executed, the SOC when arriving at the destination becomes a small value and thus, a fuel efficiency of the vehicle is improved. In contrast, when it is determined that the execution frequency of the forced charge control is high, the vehicle does not execute the low SOC control when the vehicle travels between the predetermined location and the destination.

### SUMMARY

A vehicle that can travel in an EV priority mode when an EV switch is turned on is known. The EV priority mode is a traveling mode in which an electric motor is preferentially used as a drive source. This vehicle travels in the EV priority mode when the EV switch is turned on when the SOC is equal to or higher than a predetermined value. The disclosure of JP 2019-055607 A can be applied to this vehicle. However, since this vehicle tends to have a small SOC when the low SOC control is being executed, the vehicle tends to be in a state in which the vehicle cannot travel in the EV priority mode.

In consideration of the facts described above, an object of the present disclosure is to acquire a vehicle control device in which a low SOC control can be executed while traveling in an EV priority mode is hardly hindered.

The vehicle control device according to a first aspect includes: an electric motor and an internal combustion engine that serve as a drive source of a vehicle; a battery that is able to store electric power generated by the electric motor and that is able to supply the stored electric power to the electric motor; a drive source control unit that puts the vehicle in an EV priority mode in which the electric motor is preferentially used as the drive source when an SOC that is a charge rate of the battery is equal to or higher than an EV-SW permission SOC that is lower than a normal target SOC of the battery and when an EV switch provided in the vehicle is turned on, and that prohibits the vehicle from being put in the EV priority mode when the SOC is less than the EV-SW permission SOC; a parking determination unit that determines whether the vehicle is in a long-term parking state in which the vehicle is parked for a time longer than a first threshold value at a destination of a travel route that the vehicle is traveling, based on a travel history of the vehicle; a low SOC control unit that executes a low SOC control in which a specific target SOC is set to a value lower than the normal target SOC when the parking determination unit determines that the vehicle is in the long-term parking state, the specific target SOC being a target SOC of the battery when the vehicle traveling from a predetermined location of the travel route toward the destination arrives at the destination; and a frequency determination unit that determines whether a prohibition frequency at which the drive source control unit prohibits the vehicle from being put in the EV priority mode is equal to or higher than a second threshold value when the vehicle has traveled between the predetermined location and the destination in the past in a state in which the target SOC is set to a value lower than the EV-SW permission SOC, in which when the frequency determination unit determines that the prohibition frequency is equal to or higher than the second threshold value and when the vehicle travels between the predetermined location and the destination, the low SOC control unit adjusts at least one of the specific target SOC and the EV-SW permission SOC such that the specific target SOC becomes a value that is equal to or higher than the EV-SW permission SOC.

The drive source control unit of the vehicle control device according to claim 1 puts the vehicle in the EV priority mode in which the electric motor is preferentially is used as the drive source, when the SOC that is the charge rate of the battery is equal to or higher than the EV-SW permission SOC that is lower than the normal target SOC and the EV switch provided in the vehicle is turned on. On the other hand, when the SOC is less than the EV-SW permission SOC, the drive source control unit prohibits the vehicle from being put in the EV priority mode. Further, the parking determination unit determines whether the vehicle is in the long-term parking state in which the vehicle is parked for a time longer than the first threshold value at the destination of the travel route that the vehicle is traveling, based on the travel history of the vehicle. Moreover, the low SOC control unit executes the low SOC control in which the specific target SOC is set to a value lower than the normal target SOC when the parking determination unit determines that the vehicle is in the long-term parking state, the specific target SOC being the target SOC of the battery when the vehicle traveling from the predetermined location of the travel route toward the destination arrives at the destination. The frequency determination unit determines whether the prohibition frequency at which the drive source control unit prohibits the vehicle from being put in the EV priority mode is equal to or higher than the second threshold value when the vehicle has traveled between the predetermined location and the destination in the past in a state in which the specific target SOC is set to a value lower than the EV-SW permission SOC. Further, when the frequency determination unit determines that the prohibition frequency is equal to or higher than the second threshold value, and when the vehicle travels between the predetermined location and the destination, the low SOC control unit adjusts at least one of the specific target SOC and the EV-SW permission SOC such that the specific target SOC becomes a value that is equal to or higher than the EV-SW permission SOC.

It is assumed that the prohibition frequency when the vehicle has traveled between the predetermined location and the destination in the past in a state in which the specific target SOC is lower than the EV-SW permission SOC is determined to be equal to or higher than the second threshold value. In this case, when the vehicle subsequently travels between the predetermined location and the destination in a state in which the specific target SOC is lower than the EV-SW permission SOC, the prohibition frequency at which the vehicle is prohibited from being put in the EV priority mode tends to be equal to or higher than the second threshold value. Thus, in such a case, the low SOC control unit 123 changes at least one of the specific target SOC and the EV-SW permission SOC so that the specific target SOC becomes a value that is equal to or higher than the EV-SW permission SOC. In this case, even when the vehicle travels between the predetermined location and the destination while executing the low SOC control, it is difficult to prohibit the vehicle from being put in the EV priority mode. That is, the vehicle can execute the low SOC control, but is hardly hindered from traveling in the EV priority mode.

Further, it is assumed that the prohibition frequency when the vehicle has traveled between the predetermined location and the destination in the past in a state in which the specific target SOC is lower than the EV-SW permission SOC is determined to be less than the second threshold value. In this case, when the vehicle subsequently travels between the predetermined location and the destination in a state in which the specific target SOC is lower than the EV-SW permission SOC, the prohibition frequency tends to be less than the second threshold value. Thus, even when the vehicle executing the low SOC control travels between the predetermined location and the destination in a state in which the specific target SOC is lower than the EV-SW permission SOC, the vehicle is hardly prohibited from being put in the EV priority mode. That is, the vehicle can execute the low SOC control, but is hardly hindered from traveling in the EV priority mode.

In the vehicle control device according to the disclosure according to claim 2, in the disclosure according to claim 1, when the travel history indicates that the vehicle was parked at the destination in the past for a time longer than the first threshold value for the number of times equal to or higher than a third threshold value, the parking determination unit determines that the vehicle is in the long-term parking state.

In the disclosure according to claim 2, when the travel history indicates that the vehicle was parked at the destination in the past for a time longer than the first threshold value for a number of times equal to or higher than the third threshold value, the parking determination unit determines that the vehicle is in the long-term parking state. Thus, the disclosure according to claim 2 can determine with high accuracy whether the vehicle will be in the long-term parking state.

In the vehicle control device according to the disclosure according to claim 3, in the disclosure according to claim 1 or 2, when the low SOC control unit determines that the prohibition frequency is equal to or higher than the second threshold value, the low SOC control unit sets the specific target SOC to a value higher than the EV-SW permission SOC.

According to the disclosure according to claim 3, the specific target SOC of the battery is not set to a value that is unnecessarily small by the low SOC control unit. Thus, since the possibility that the SOC of the battery becomes an excessively low value is low, and the possibility that battery deteriorates is reduced.

In the vehicle control device according to the disclosure according to claim 4, in the disclosure according to claim 1 or 2, when the low SOC control unit determines that the prohibition frequency is equal to or higher than the second threshold value, the low SOC control unit sets the EV-SW permission SOC to a value lower than the specific target SOC.

In the disclosure according to claim 4, since the EV-SW permission SOC is set to a low value, even when the SOC of the battery becomes a small value, the traveling of the vehicle in the EV priority mode is hardly hindered.

In the vehicle control device according to the disclosure according to claim 5, in the disclosure according to claim 3 or 4, when the low SOC control unit determines that the prohibition frequency is less than the second threshold value, the low SOC control unit sets the specific target SOC to a value lower than the EV-SW permission SOC.

In the disclosure according to claim 5, when the prohibition frequency is determined to be less than the second threshold value, the low SOC control unit sets the specific target SOC to a value lower than the EV-SW permission SOC. Therefore, it becomes easier to improve fuel efficiency by the low SOC control.

In the vehicle control device according to the disclosure according to claim 6, in the disclosure according to any one of claims 1 to 5, when the vehicle has traveled between the predetermined location and the destination in the past in a state in which the specific target SOC is lower than the EV-SW permission SOC, the frequency determination unit determines whether an operation frequency at which the EV switch is turned on is equal to or higher than a fourth threshold value, and when the frequency determination unit determines that the prohibition frequency is equal to or higher than the second threshold value and that the operation frequency is equal to or higher than the fourth threshold value, and when the vehicle travels between the predetermined location and the destination, the low SOC control unit adjusts at least one of the specific target SOC and the EV-SW permission SOC such that the specific target SOC becomes a value that is equal to or higher than the EV-SW permission SOC.

In the disclosure according to claim 6, when the frequency determination unit determines that the prohibition frequency is equal to or higher than the second threshold value and that the operation frequency is equal to or higher than the fourth threshold value, and when the vehicle travels between the predetermined location and the destination, the low SOC control unit adjusts at least one of the specific target SOC and the EV-SW permission SOC such that the specific target SOC becomes a value that is equal to or higher than the EV-SW permission SOC. In this case, when the EV priority mode is turned on while the vehicle travels between the predetermined location and the destination while executing the low SOC control, it is difficult to prohibit the vehicle from being put in the EV priority mode. That is, the vehicle can execute the low SOC control, but is hardly hindered from traveling in the EV priority mode.

The vehicle control device according to claim 7 includes: an electric motor and an internal combustion engine that serve as a drive source of a vehicle; a battery that is able to store electric power generated by the electric motor and that is able to supply the stored electric power to the electric motor; a drive source control unit that puts the vehicle in an EV priority mode in which the electric motor is preferentially used as the drive source when an SOC that is a charge rate of the battery is equal to or higher than an EV-SW permission SOC that is lower than a normal target SOC of the battery and when an EV switch provided in the vehicle is turned on, and that prohibits the vehicle from being put in the EV priority mode when the SOC is less than the EV-SW permission SOC; a parking determination unit that determines whether the vehicle is in a long-term parking state in which the vehicle is parked for a time longer than a first threshold value at a destination of a travel route that the vehicle is traveling, based on a travel history of the vehicle; a low SOC control unit that executes a low SOC control in which a specific target SOC is set to a value lower than the normal target SOC when the parking determination unit determines that the vehicle is in the long-term parking state, the specific target SOC being a target SOC of the battery when the vehicle traveling from a predetermined location of the travel route toward the destination arrives at the destination; and a frequency determination unit that determines whether an operation frequency at which the EV switch is turned on is equal to or higher than a fourth threshold value when the vehicle has traveled between the predetermined location and the destination in the past in a state in which the target SOC is set to a value lower than the EV-SW permission SOC, in which when the frequency determination unit determines that the operation frequency is equal to or higher than the fourth threshold value, and when the vehicle travels between the predetermined location and the destination, the low SOC control unit adjusts at least one of the specific target SOC and the EV-SW permission SOC such that the specific target SOC becomes a value that is equal to or higher than the EV-SW permission SOC.

It is assumed that the operation frequency when the vehicle has traveled between the predetermined location and the destination in the past in a state in which the specific target SOC is lower than the EV-SW permission SOC is determined to be equal to or higher than the fourth threshold value. In this case, when the vehicle subsequently travels between the predetermined location and the destination in a state in which the specific target SOC is lower than the EV-SW permission SOC, the EV switch is easily turned on. Thus, the frequency at which the vehicle is prohibited from being put in the EV priority mode tends to increase. Thus, in such a case, the low SOC control unit 123 changes at least one of the specific target SOC and the EV-SW permission SOC so that the specific target SOC becomes a value that is equal to or higher than the EV-SW permission SOC. In this case, even when the vehicle travels between the predetermined location and the destination while executing the low SOC control, it is difficult to prohibit the vehicle from being put in the EV priority mode. That is, the vehicle can execute the low SOC control, but is hardly hindered from traveling in the EV priority mode.

Further, it is assumed that the operation frequency when the vehicle has traveled between the predetermined location and the destination in the past in a state in which the specific target SOC is lower than the EV-SW permission SOC is determined to be less than the fourth threshold value. In this case, when the vehicle subsequently travels between the predetermined location and the destination in a state in which the specific target SOC is lower than the EV-SW permission SOC, the EV switch is hardly turned on. Thus, the frequency at which the vehicle is prohibited from being put in the EV priority mode hardly increases. That is, the vehicle can execute the low SOC control, but is hardly hindered from traveling in the EV priority mode.

As described above, the vehicle control device according to the present disclosure has an excellent effect in which the low SOC control can be executed while traveling in the EV priority mode is hardly hindered.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a vehicle control device and a vehicle controlled by the vehicle control device according to a first embodiment;

FIG. 2 is a control block diagram of an ECU of the vehicle;

FIG. 3 is a functional block diagram of the ECU shown in FIG. 2;

FIG. 4 is a functional block diagram of a hardware of an external server shown in FIG. 1;

FIG. 5 is a diagram showing a travel history when the vehicle of the first embodiment has traveled in a specific traveling section in the past;

FIG. 6 is a timing chart showing states of SOC, EV priority mode, and low SOC control when the vehicle of the first embodiment travels in the specific traveling section;

FIG. 7 is a flowchart showing a process executed by the external server of the first embodiment;

FIG. 8 is a flowchart showing a process executed by the ECU of the vehicle of the first embodiment;

FIG. 9 is a timing chart showing the states of SOC, EV priority mode, and low SOC control when the vehicle of the comparative example travels in the specific traveling section;

FIG. 10 is a timing chart showing states of SOC, EV priority mode, and low SOC control when the vehicle of the second embodiment travels in the specific traveling section;

FIG. 11 is a flowchart showing a process executed by the ECU of the vehicle of the second embodiment;

FIG. 12 is a diagram showing the travel history when the vehicle of the third embodiment has traveled in the specific traveling section in the past;

FIG. 13 is a flowchart showing a process executed by the external server of the third embodiment;

FIG. 14 is a flowchart showing a process executed by the ECU of the vehicle of the third embodiment; and

FIG. 15 is a flowchart showing a process executed by the ECU of the vehicle of the fourth embodiment.

### DETAILED DESCRIPTION OF EMBODIMENTS

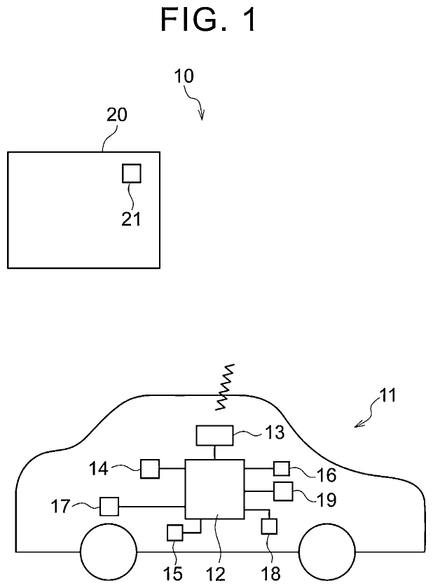

Hereinafter, the first embodiment of the vehicle control device 10 according to the present disclosure will be described with reference to FIGS. 1 to 9.

As shown in FIG. 1, a vehicle control device 10 that controls a vehicle 11 includes each device mounted on the vehicle 11 and an external server 20. The vehicle 11 is given an ID representing the vehicle 11.

The vehicle 11 includes an electronic control unit (ECU) 12, a wireless communication device 13, a GPS receiver 14, an internal combustion engine 15, an electric motor 16, a battery 17, an EV switch 18, and a display 19. The wireless communication device 13, the GPS receiver 14, the internal combustion engine 15, the electric motor 16, the battery 17, the EV switch 18, and the display 19 are connected to the ECU 12.

The internal combustion engine 15 and the electric motor 16 are connected to drive wheels (not shown) via a power transmission mechanism (not shown). That is, the vehicle 11 is a hybrid electric vehicle having the internal combustion engine 15 and the electric motor 16 as drive sources. Thus, a traveling mode of the vehicle 11 includes an EV priority mode (also referred to as an EV mode) in which the electric motor 16 is preferentially used as a drive source, and an HV mode in which the internal combustion engine 15 and the electric motor 16 are used as drive sources.

The internal combustion engine 15 operates, for example, by burning gasoline. The electric motor 16 operates by being supplied with electric power from the battery 17. Further, the electric motor 16 also functions as a generator. For example, when the internal combustion engine 15 operates as a drive source, the electric motor 16 can function as a generator. Although not shown, the electric motor 16 of the present embodiment includes two electric motors. Both of these two electric motors can function as an electric motor (drive source) and a generator. The electric power generated by the electric motor 16 is stored in the battery 17.

The battery 17 is, for example, a nickel hydrogen secondary battery or a lithium ion secondary battery. When the ignition switch (or start button) of the vehicle 11 is in the on position, the ECU 12 (drive source control unit 122) selects at least one of the internal combustion engine 15 and the electric motor 16 as a drive source so that a state of charge (SOC) of the battery 17 becomes a size near a predetermined target SOC. This target SOC includes a normal target SOC and a specific target SOC. The specific target SOC is a target SOC when the ECU 12 executes a low SOC control described later. More specifically, the specific target SOC is a target SOC when the vehicle 11 reaches a destination G described later. The specific target SOC of the present embodiment includes a specific target SOC (a) and a specific target SOC (b) described later. On the other hand, the normal target SOC is a target SOC when the ECU 12 executes a normal control. In other words, the normal target SOC is the target SOC when the ECU 12 does not perform the low SOC control. A magnitude relationship between these values is shown in FIG. 6. That is, the normal target SOC>the specific target SOC (b)>the specific target SOC (a) is satisfied. For example, the value of the normal target SOC is 63%. For example, the value of the specific target SOC (a) is 42%, and the value of the specific target SOC (b) is 48%.

The wireless communication device 13 can wirelessly communicate with a wireless communication device 21 of the external server 20.

The GPS receiver 14 repeatedly acquires location information (latitude, longitude, and the like) of the point where the vehicle 11 is traveling based on a GPS signal transmitted from an artificial satellite at a predetermined cycle.

The EV switch 18 and the display 19 are provided, for example, on the instrument panel (not shown) of the vehicle 11. As will be described later, when the EV switch 18 is moved to the on position by an occupant under a predetermined condition, the traveling mode of the vehicle 11 is switched to the “EV priority mode”. The EV priority mode is basically a traveling mode in which the vehicle 11 is driven by a driving force generated by the electric motor 16 without transmitting the torque generated by the internal combustion engine 15 to the driving wheels of the vehicle 11.

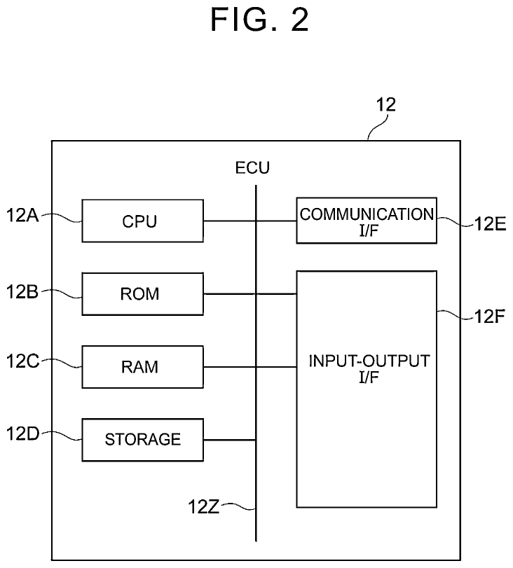

As shown in FIG. 2, the ECU 12 includes a central processing unit (CPU: processor) 12A, a read only memory (ROM) 12B, a random access memory (RAM) 12C, a storage 12D, a communication interface (I/F) 12E, and an input-output I/F 12F. The CPU 12A, the ROM 12B, the RAM 12C, the storage 12D, the communication I/F 12E, and the input-output I/F 12F are connected to each other so as to be able to communicate with each other via a bus 12Z. The ECU 12 can acquire information on date and time from a timer (not shown).

The CPU 12A is a central arithmetic processing unit that executes various programs and controls each unit. That is, the CPU 12A reads the program from the ROM 12B or the storage 12D, and executes the program using the RAM 12C as a work area. The CPU 12A controls each of the above components and performs various arithmetic processes in accordance with the program recorded in the ROM 12B or the storage 12D.

The ROM 12B stores various programs and various data. The RAM 12C temporarily stores a program or data as a work area. The storage 12D is composed of a storage device such as a hard disk drive (HDD) or a solid state drive (SSD), and stores various programs and various data. The communication I/F 12E is an interface for communicating with other devices. The input-output I/F 12F is an interface for communicating with various devices.

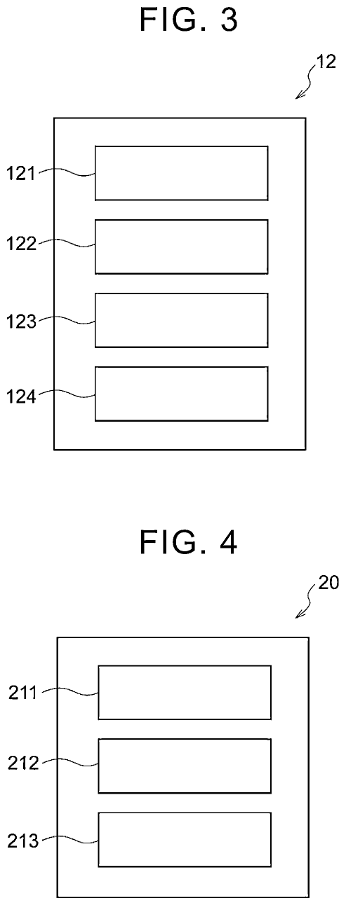

FIG. 3 shows an example of a functional configuration of the ECU 12 in a block diagram. The ECU 12 has a travel route prediction unit 121, the drive source control unit 122, a low SOC control unit 123, and a communication control unit 124 as functional configurations. The travel route prediction unit 121, the drive source control unit 122, the low SOC control unit 123, and the communication control unit 124 are realized as the CPU 12A reads and executes a program stored in the ROM 12B.

The travel route prediction unit 121 predicts the travel route of the vehicle 11 based on information input to the car navigation system, vehicle speed information of the vehicle 11, steering angle information of the vehicle 11, operation information of a direction indicator (not shown), and location information received by the GPS receiver 14.

Based on a plurality of pieces of information, the drive source control unit 122 determines the traveling mode of the vehicle 11 and selects at least one of the internal combustion engine 15 and the electric motor 16 as the drive source. This information includes at least the accelerator operation amount of an accelerator pedal (not shown), the SOC of the battery 17, the vehicle speed of the vehicle 11, and the presence/absence of an on operation of the EV switch 18. When the SOC of the battery 17 becomes a size equal to or less than the forced charge SOC that is a value lower than the specific target SOC (a), the drive source control unit 122 forcibly rotates the internal combustion engine 15.

The drive source control unit 122 determines whether to set the traveling mode of the vehicle 11 to the “EV priority mode”. That is, when the SOC of the battery 17 is equal to or higher than the EV-SW permission SOC and the EV switch 18 is in the on position, the drive source control unit 122 sets the traveling mode of the vehicle 11 to the “EV priority mode”. On the other hand, when the SOC of the battery 17 is less than the EV-SW permission SOC, the drive source control unit 122 does not set the traveling mode of the vehicle 11 to the “EV priority mode”. A magnitude relationship between the EV-SW permission SOC, the normal target SOC, the specific target SOC (a), and the specific target SOC (b) of the present embodiment are shown in FIG. 6. That is, the magnitude relationship between these values is as follows, normal target SOC>specific target SOC (b)>EV-SW permission SOC>specific target SOC (a). For example, the value of EV-SW permission SOC is 43%.

As will be described later, when the parking determination unit 211 of the external server 20 determines that “the vehicle is in a long-term parking state”, the low SOC control unit 123 sets the target SOC of the battery 17 when the vehicle 11 travels a specific traveling section RS described below to the specific target SOC that is a value lower than the normal target SOC. That is, the vehicle 11 is controlled so that the SOC when the vehicle 11 reaches the destination G becomes the specific target SOC. The control for setting the target SOC of the battery 17 when the vehicle 11 travels in the specific traveling section RS to the specific target SOC that is a value lower than the normal target SOC is referred to as the low SOC control.

The communication control unit 124 controls the wireless communication device 13.

The external server 20 has a CPU, a ROM, a RAM, a storage, a communication I/F, and an input-output I/F as a hardware configuration. The CPU, the ROM, the RAM, the storage, the communication I/F, and the input-output I/F are connected to each other so as to be able to communicate with each other via a bus. The external server 20 can acquire information on date and time from a timer (not shown).

In the storage of the external server 20, travel history information of a large number of vehicles including the vehicle 11 is recorded in association with an ID of each of the vehicles. The travel history information of each of the vehicles is wirelessly transmitted from the wireless communication device 13 of each of the vehicles to the wireless communication device 21 of the external server 20. This travel history information includes the travel route actually traveled by each of the vehicles and the place where each of the vehicles actually parked. Further, the travel history information includes the date and time, and the number of times each of the vehicles traveled on each of the travel routes, and the date and time, the parking time, and the number of times the vehicle parked at each of the parking places. Further, the travel history information includes information on the location (location information), the number of times, and the date and time when the EV switch 18 is turned on, and information on the location (location information), the number of times, and the date and time when the EV priority mode is prohibited. Further, in the storage of the external server 20, information on the travel route of each of the vehicles predicted by the travel route prediction unit 121 received by the external server 20 from the wireless communication device 13 is storage.

FIG. 4 shows an example of the functional configuration of the hardware of the external server 20 as a block diagram. The hardware of the external server 20 has a parking determination unit 211, a frequency determination unit 212, and a communication control unit 213 as functional configurations. The parking determination unit 211, the frequency determination unit 212, and the communication control unit 213 are realized as the CPU reads and executes the program stored in the ROM.

The parking determination unit 211 predicts a destination (end point) G of the travel route of the vehicle 11 based on the predicted travel route, the current date and time, weather information, and the travel history information recorded in the storage. Further, the parking determination unit 211 predicts the length of the parking time of the vehicle 11 at the predicted destination G. That is, the parking determination unit 211 determines whether the length of the parking time of the vehicle 11 at the destination G is longer than a predetermined first threshold value. In the present specification, the parking state of the vehicle 11 for a time longer than the first threshold value is referred to as a long-term parking state. On the other hand, the parking state of the vehicle 11 over a length equal to or less than the first threshold value is called a short-term parking state. The first threshold value is, for example, 6 hours. The first threshold value is recorded in the ROM of the external server 20. A method of estimating the destination of the travel route of the vehicle and the parking state at the destination based on the each of the above-mentioned information is well known. For example, the destination of the travel route of the vehicle and the parking state at the destination can be estimated by the method disclosed in JP 2019-055607 A.

The frequency determination unit 212 determines a discharge point P that is a predetermined location in front of the estimated destination G of the travel route by a predetermined distance. The section between the destination G and the discharge point P of the travel route is a specific traveling section RS. Further, based on the information on the place and the date and time at which the execution of the EV priority mode is prohibited included in the travel history information, the frequency determination unit 212 calculates the prohibition frequency that is the frequency at which the execution of the EV priority mode is prohibited when the vehicle 11 has traveled on the specific traveling section RS in the past.

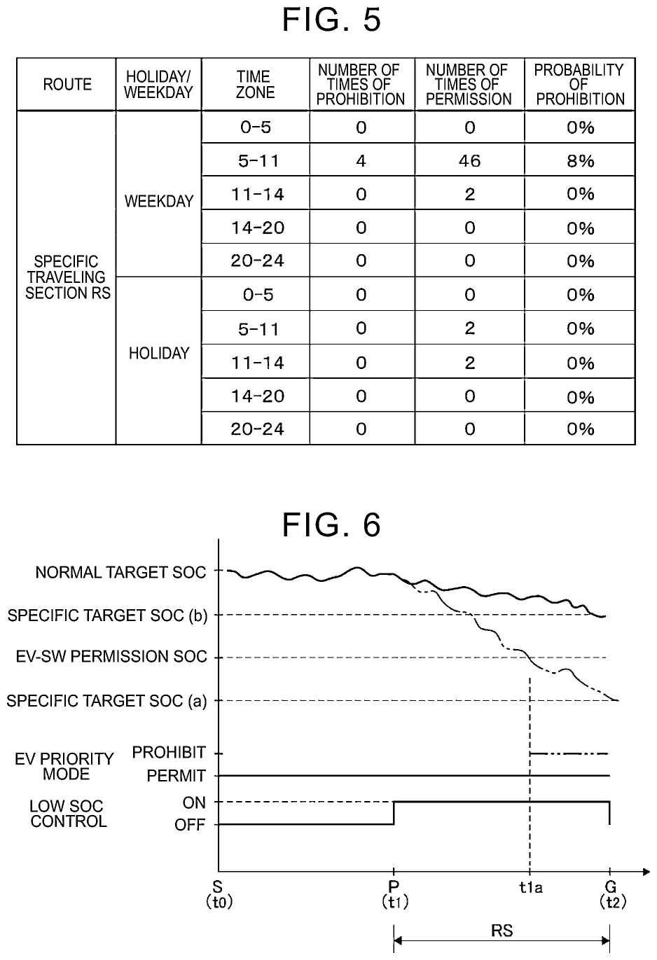

FIG. 5 shows an example of the prohibition frequency (travel history) in which the execution of the EV priority mode is prohibited when the vehicle 11 has traveled on the specific traveling section RS in the past. More specifically, FIG. 5 shows the prohibition frequency at which the execution of the EV priority mode is prohibited, when the vehicle 11 that has executed the low SOC control while setting the target SOC of the battery 17 to the specific target SOC (a) travels on the specific traveling section RS. The data represented by FIG. 5 is recorded in the ROM of the external server 20. FIG. 5 shows that the vehicle 11 has traveled the specific traveling section RS 56 times in total in the past. For example, in the time zone between 5 o'clock and 11 o'clock on a weekday, the vehicle 11 was prohibited from executing the EV priority mode for a total of four times. Further, in the time zone between 5 o'clock and 11 o'clock on a weekday, the vehicle 11 was permitted to execute the EV priority mode for a total of 46 times. Here, the execution of the EV priority mode being prohibited includes the shift to the EV priority mode being prohibited by the drive source control unit 122 when the EV switch 18 at the off position is moved to the on position, and includes the EV priority mode that is being executed being stopped by the drive source control unit 122. In contrast, the execution of the EV priority mode being permitted includes the traveling mode being shifted to the EV priority mode by the drive source control unit 122 when the EV switch 18 in the off position is moved to the on position, and includes the EV priority mode that is being executed being continuously executed by the drive source control unit 122. FIG. 5 shows that in the time zone between 5 o'clock and 11 o'clock on a weekday, the vehicle 11 is prohibited from executing the EV priority mode for only 4 times during 50 times during traveling. That is, FIG. 5 shows that the execution of the EV priority mode is prohibited by an 8% probability in the time zone between 5 o'clock and 11 o'clock on a weekday. The probability that the EV priority mode is prohibited from being executed in other time zones is 0%.

The communication control unit 213 controls the wireless communication device 21.

Operations and Effects

Next, operations and effects of the first embodiment will be described.

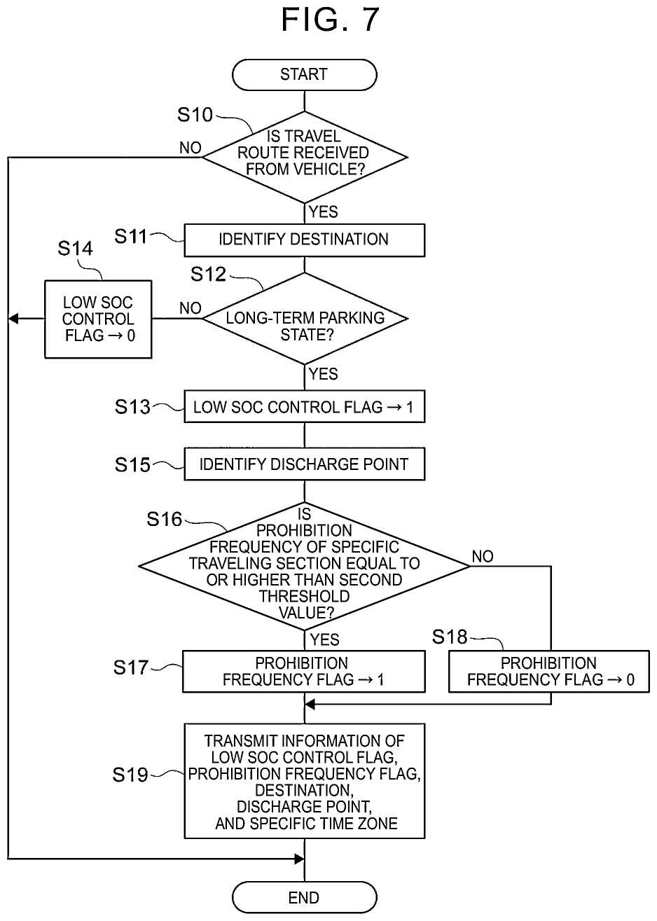

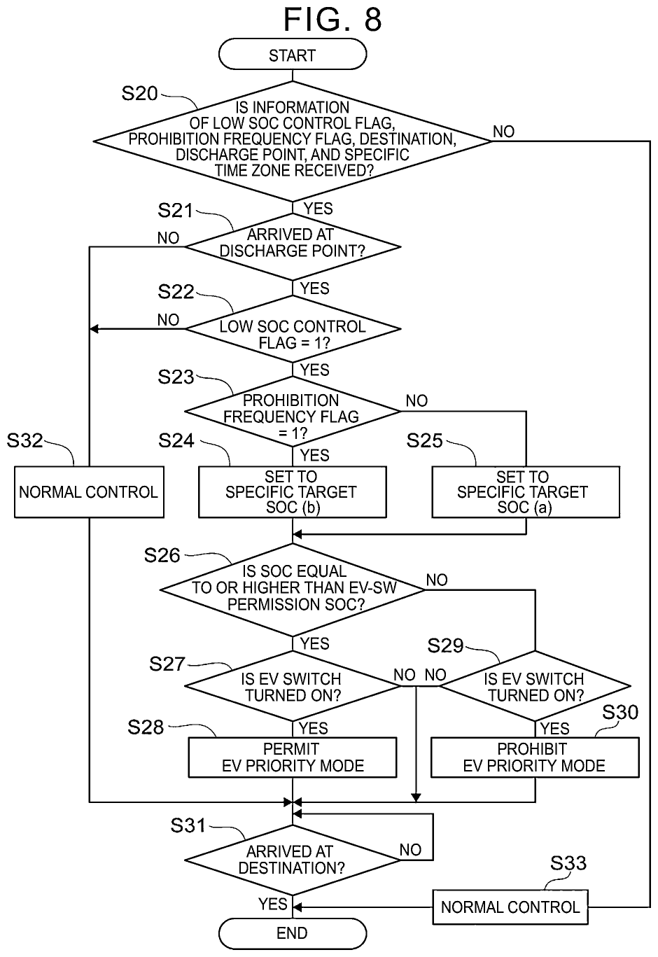

Subsequently, the flowcharts of FIGS. 7 and 8 are used to explain the operation of the ECU 12 of the vehicle 11 and the external server 20 when the vehicle 11 travels on the travel route predicted by the travel route prediction unit 121 in the embodiment shown in FIG. 6. At time t0 in FIG. 6, the vehicle 11 departs from a start point S of the travel route. At time t1, the vehicle 11 passes the discharge point P. Further, at time t2, the vehicle 11 reaches the destination G. As shown in FIG. 6, between time t0 and time t1, the target SOC of the battery 17 is usually set to the normal target SOC. That is, the vehicle 11 is normally controlled by the drive source control unit 122 in this time zone.

First, the process of the flowchart of FIG. 7 will be described. The external server 20 (CPU) repeatedly executes the process shown in the flowchart of FIG. 7 every time a predetermined time elapses.

In step S10, the external server 20 determines whether the information on the travel route of the vehicle 11 predicted by the travel route prediction unit 121 is received from the vehicle 11.

The external server 20 that determines Yes in step S10 proceeds to step S11, and the parking determination unit 211 predicts the destination G of the travel route of the vehicle 11 based on the predicted travel route, the current date and time, the weather information, and the travel history information.

The external server 20 that has completed the process of step S11 proceeds to step S12, and the parking determination unit 211 determines whether the vehicle 11 is in the long-term parking state at the destination G.

The external server 20 that determines Yes in step S12 proceeds to step S13, and the parking determination unit 211 sets the value of the low SOC control flag to “1”. The initial value of the low SOC control flag is “0”.

On the other hand, when the external server 20 determines No in step S12 and proceeds to step S14, the parking determination unit 211 sets the value of the low SOC control flag to “0”.

The external server 20 that has completed the process of step S13 proceeds to step S15, and the parking determination unit 211 determines the discharge point P.

The external server 20 that has completed the process of step S15 proceeds to step S16, and the frequency determination unit 212 calculates the prohibition frequency at which the execution of the EV priority mode is prohibited when the vehicle 11 has traveled in the specific traveling section RS between the destination G and the discharge point P in the past. Further, the frequency determination unit 212 determines whether the obtained prohibition frequency is equal to or higher than a predetermined second threshold value. The second threshold value of the present embodiment is 5%. However, the second threshold value may be a different value. When the current time is included in the time zone of 5 to 11 o'clock on a weekday, the frequency determination unit 212 determines Yes in step S16 and proceeds to step S17.

The frequency determination unit 212 of the external server 20 that has proceeded to step S17 sets the value of the prohibition frequency flag to “1”. The initial value of the prohibition frequency flag is “0”.

When the external server 20 determines No in step S16 and proceeds to step S18, the frequency determination unit 212 sets the value of the prohibition frequency flag to “0”.

The external server 20 that has completed the process of step S17 or S18 proceeds to step S19. In step S19, the wireless communication device 21 that is controlled by the communication control unit 213 wirelessly transmits to the vehicle 11 (wireless communication device 13), information on the low SOC control flag, the prohibition frequency flag, the predicted destination, the discharge point P, and the specific time zone that is a time zone in which the prohibition frequency is determines to be equal to or higher than the second threshold value.

When the determination result is No in step S10 or when the processes of steps S14 and S19 are completed, the external server 20 temporarily ends the process of the flowchart of FIG. 7.

Next, the process of the flowchart of FIG. 8 performed by the ECU 12 of the vehicle 11 will be described. The ECU 12 repeatedly executes the process of the flowchart of FIG. 8 every time a predetermined time elapses.

First, in step S20, the low SOC control unit 123 of the ECU 12 determines whether the wireless communication device 13 has received information on the low SOC control flag, the prohibition frequency flag, the predicted destination, the discharge point P, and the specific time zone, and whether these pieces of information are recorded in the storage 12D.

The low SOC control unit 123 of the ECU 12 that determines Yes in step S20 proceeds to step S21, and determines whether the vehicle 11 has reached the discharge point P based on the information from the car navigation system and the location information received by the GPS receiver 14. For example, when the current time is t1 in FIG. 6, the ECU 12 determines Yes in step S21 and proceeds to step S22. On the other hand, when the current time is a time before t1, the ECU 12 determines No in step S21.

In step S22, the low SOC control unit 123 determines whether the value of the low SOC control flag is “1”.

The ECU 12 that determines Yes in step S22 proceeds to step S23, and the low SOC control unit 123 determines whether the value of the prohibition frequency flag is “1” and whether the current time is included in the specific time zone.

The ECU 12 that determines Yes in step S23 proceeds to step S24, and the low SOC control unit 123 sets the target SOC of the battery 17 to the specific target SOC (b). On the other hand, the ECU 12 that determines No in step S23 proceeds to step S25, and the low SOC control unit 123 sets the target SOC of the battery 17 to the specific target SOC (a). For example, at time t1 in FIG. 6, the ECU 12 performs the process of step S24 or S25, so that the low SOC control unit 123 executes the low SOC control. As shown in FIG. 6, the low SOC control unit 123 executes the low SOC control during the time between time t1 and time t2. When the ECU 12 performs the process of step S24, as shown by the solid line in FIG. 6, the value of the SOC that was a value near the normal target SOC at time t1 becomes smaller with the passage of time, and becomes close to the specific target size near the specific target SOC (b) at time t2. On the other hand, when the ECU 12 performs the process of step S25, as shown by the virtual line in FIG. 6, the value of the SOC that is near the normal target SOC at time t1 becomes smaller with the passage of time, and the value becomes the size close to the specific target SOC (a) at time t2.

After completing the process of step S24 or S25, the ECU 12 proceeds to step S26 and determines whether the SOC of the battery 17 is equal to or higher than the EV-SW permission SOC.

For example, when the ECU 12 performs the process of step S24, the SOC of the battery 17 becomes a value equal to or higher than the EV-SW permission SOC between time t1 and time t2, as is clear from FIG. 6. Therefore, in this case, the ECU 12 determines Yes in step S26 and proceeds to step S27.

In step S27, the drive source control unit 122 of the ECU 12 determines whether the EV switch 18 is in the on position. The drive source control unit 122 that determines Yes in step S27 proceeds to step S28. In this case, since the SOC of the battery 17 is a value equal to or higher than the EV-SW permission SOC as described above, the drive source control unit 122 permits the traveling mode of the vehicle 11 to be the EV priority mode in step S28 (see the solid line in FIG. 6).

On the other hand, when the ECU 12 performs the process of step S25, the SOC of the battery 17 becomes a value less than the EV-SW permission SOC, for example, between time t1a and time t2, as is clear from FIG. 6. Time t1a is a time between time t1 and time t2. Thus, for example, at time t1a, the ECU 12 determines No in step S26 and proceeds to step S29.

In step S29, the drive source control unit 122 of the ECU 12 determines whether the EV switch 18 is in the on position. The drive source control unit 122 that determines Yes in step S29 proceeds to step S30. In this case, as described above, the SOC of the battery 17 is a value less than the EV-SW permission SOC. Thus, for example, when the ECU 12 performs the process of step S30 at time t1a, the drive source control unit 122 prohibits the traveling mode of the vehicle 11 from being put in the EV priority mode (see the virtual line in FIG. 6). When the EV priority mode is prohibited, the contents are displayed on the display 19.

After completing the process of step S28 or S30, the ECU 12 proceeds to step S31 and determines whether the vehicle 11 has reached the destination G based on the location information received by the GPS receiver 14.

Further, the ECU 12 that determines No in step S21 or S22 proceeds to step S32, and the drive source control unit 122 executes normal control. That is, in this case, the drive source control unit 122 executes the normal control while the vehicle 11 travels from the start point S to the destination G. Further, the ECU 12 that determines No in step S20 proceeds to step S33, and the drive source control unit 122 executes the normal control.

When it is determined Yes in step S31, the ECU 12 temporarily ends the process of the flowchart of FIG. 8.

As described above, in the vehicle control device 10 of the present embodiment, when the SOC of the battery 17 is equal to or higher than the EV-SW permission SOC lower than the normal target SOC and the EV switch 18 is turned on, the drive source control unit 122 of the ECU 12 of the vehicle 11 sets the vehicle 11 to the EV priority mode in which the electric motor 16 is preferentially used with the vehicle 11 as the drive source. On the other hand, when the SOC is less than the EV-SW permission SOC, the drive source control unit 122 prohibits the vehicle 11 from being put in the EV priority mode. Further, when the parking determination unit 211 of the external server 20 determines that the vehicle 11 is in a long-term parking state, the low SOC control unit 123 of the ECU 12 executes the low SOC control in which the specific target SOC that is the target SOC when the vehicle 11 travels in the specific traveling section RS is set to a value lower than the normal target SOC. Further, when the vehicle 11 has traveled in the specific traveling section RS in the past with the target SOC being a value lower than the EV-SW permission SOC (specific target SOC (a)), the frequency determination unit 212 determines whether the prohibition frequency at which the drive source control unit 122 prohibits the vehicle 11 from being put in the EV priority mode is equal to or higher than the second threshold value. Further, when the frequency determination unit 212 determines that the prohibition frequency is equal to or higher than the second threshold value and when the vehicle 11 travels on the specific traveling section RS, the specific target SOC is adjusted by the low SOC control unit 123 so that the specific target SOC is a value equal to or higher than the EV-SW permission SOC (specific target SOC (b)).

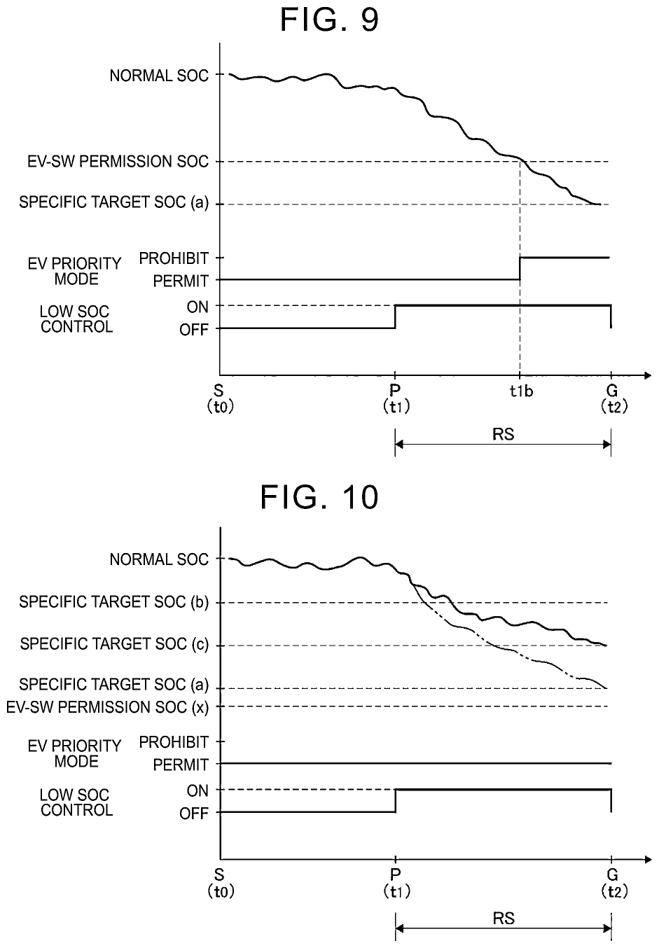

Here, the prohibition frequency when the vehicle 11 has traveled in the specific traveling section RS in the past is assumed to be equal to or higher than the second threshold value. Here, in the vehicle 11, the target SOC is the specific target SOC (a) that is lower than the EV-SW permission SOC and the EV switch 18 is turned on by the driver. The comparative example shown in FIG. 9 is an example of a case where several days after the vehicle 11 has traveled in the specific traveling section RS in such a state in the past, the vehicle 11 in which the target SOC is in a state of the specific target SOC (a) travels in the specific traveling section RS. In this comparative example, the SOC of the vehicle 11 traveling in the specific traveling section RS tends to be lower than the EV-SW permission SOC between time t1b and time t2. That is, there is a high possibility that the drive source control unit 122 executes the process of prohibiting the EV priority mode while the vehicle 11 travels once in the specific traveling section RS.

On the other hand, in the present embodiment, when the vehicle 11 travels on the specific traveling section RS, the low SOC control unit 123 sets the value of the target SOC (specific target SOC (b)) so that the SOC of the battery 17 becomes a value equal to or higher than the EV-SW permission SOC. In this case, even when the vehicle 11 travels on the specific traveling section RS while executing the low SOC control, it is difficult to prohibit the vehicle 11 from being put in the EV priority mode as compared with the comparative example. That is, the vehicle 11 can execute the low SOC control, but is hardly hindered from traveling in the EV priority mode.

Further, when the target SOC of the battery 17 is set to the specific target SOC (b) by the low SOC control, it is unlikely that the SOC becomes an excessively low value. Therefore, the risk of deterioration of the battery 17 is reduced.

Further, the prohibition frequency when the vehicle 11 has traveled in the specific traveling section RS in the past is assumed to be less than the second threshold value. Here, in the vehicle 11, the target SOC is the specific target SOC (a) that is lower than the EV-SW permission SOC and the EV switch 18 is turned on by the driver. In this case, when the vehicle 11 in which the target SOC is in the state of the specific target SOC (a) subsequently travels on the specific traveling section RS, the SOC of the vehicle 11 traveling on the specific traveling section RS tends to be equal to or higher the EV-SW permission SOC. That is, there is a low possibility that the drive source control unit 122 executes the process of prohibiting the EV priority mode while the vehicle 11 travels once in the specific traveling section RS. That is, even when the vehicle 11 executing the low SOC control travels on the specific traveling section RS in a state in which the target SOC is set to the specific target SOC (a) that is lower than the EV-SW permission SOC, the vehicle 11 is hardly prohibited from being put in the EV priority mode. That is, the vehicle 11 can execute the low SOC control, but is hardly hindered from traveling in the EV priority mode.

Further, when the target SOC is set to the specific target SOC (a) by the low SOC control, the SOC of the battery 17 becomes the magnitude close to that of the specific target SOC (a) when the vehicle 11 reaches the destination G, as shown in FIG. 6. When the driver turns on the ignition switch (or the start button) of the vehicle 11 after the vehicle 11 is in the long-term parking state at the destination G, the internal combustion engine 15 is started and the vehicle 11 is in the warm-up operation state. During this warm-up operation, the electric motor 16 operates as a generator, and the electric power generated by the electric motor 16 is stored in the battery 17. In this case, the SOC of the battery 17 is a small value close to the specific target SOC (a) when the ignition switch (or the start button) is turned on. Therefore, when the vehicle 11 warms up in this state, a large amount of electric power generated by the electric motor 16 is stored in the battery 17. Thus, when the SOC of the battery 17 reaches a size near the specific target SOC (a) when the vehicle 11 reaches the destination G, it becomes easy to improve the fuel efficiency of the vehicle 11.

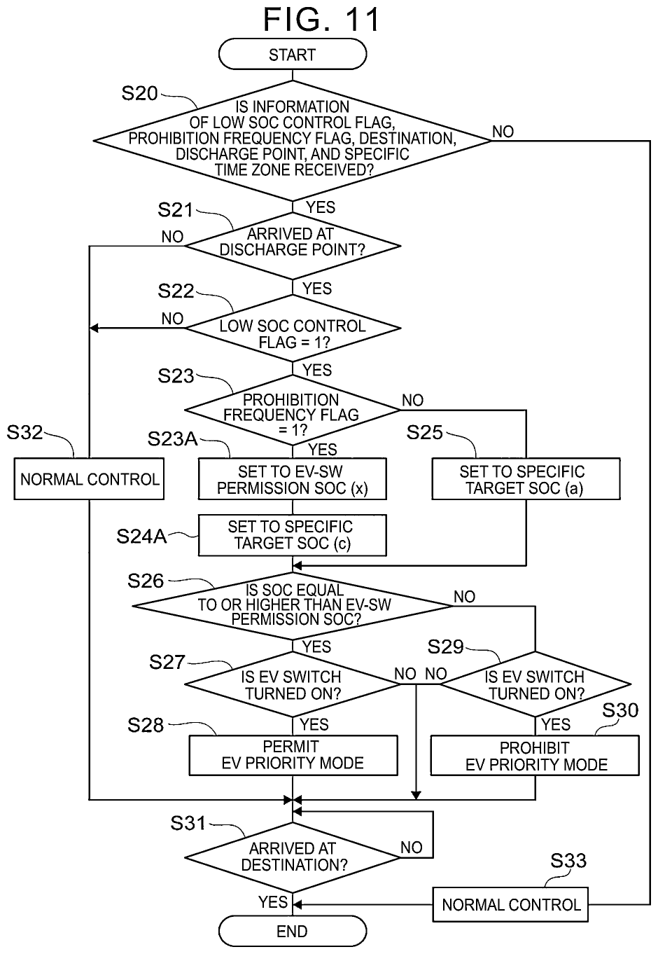

Next, a second embodiment of the vehicle control device 10 according to the present disclosure will be described with reference to FIGS. 10 and 11. The description of the technical contents in common with the first embodiment will be omitted.

A first feature of the second embodiment is that when the low SOC control unit 123 executes the low SOC control and the frequency determination unit 212 determines that the prohibition frequency is equal to or higher than the second threshold value, the low SOC control unit 123 changes the EV-SW permission SOC to a value lower than the EV-SW permission SOC when the low SOC control unit 123 does not execute the low SOC control or the frequency determination unit 212 determines that the prohibition frequency is less than the second threshold value. As shown in FIG. 10, this changed EV-SW permission SOC (x) is a value lower than the specific target SOC (a), for example 41%. However, the EV-SW permission SOC (x) may be a value equal to or higher than the specific target SOC (a) as long as it is lower than the specific target SOC (c) described later.

A second feature of the second embodiment is that when the low SOC control unit 123 executes the low SOC control and the frequency determination unit 212 determines that the prohibition frequency is equal to or higher than the second threshold value, the low SOC control unit 123 sets as the specific target SOC, the specific target SOC (c) that is lower than the specific target SOC (b) and that is higher than the specific target SOC (a).

Operations and Effects

Next, operations and effects of the second embodiment will be described.

Also in the second embodiment, the external server 20 performs the process of the flowchart of FIG. 7. On the other hand, the ECU 12 performs the process of the flowchart of FIG. 11. The flowchart of FIG. 11 differs from the flowchart of FIG. 8 only in steps S23A and 24A.

In step S23A, the low SOC control unit 123 changes the EV-SW permission SOC to the EV-SW permission SOC (x).

The ECU 12 that has completed the process of step S23A proceeds to step S24A, and the low SOC control unit 123 sets the target SOC of the battery 17 to the specific target SOC (c). For example, at time t1 in FIG. 10, the ECU 12 performs the process of step S24A and thus, the low SOC control unit 123 executes the low SOC control. When the ECU 12 performs the process of step S24A, as shown by the solid line in FIG. 10, the value of the SOC that was a value near the normal target SOC at time t1 becomes smaller with the passage of time, and becomes close to the specific target size near the specific target SOC (c) at time t2. On the other hand, when the ECU 12 performs the process of step S25, as shown by the virtual line in FIG. 10, the value of the SOC that is near the normal target SOC at time t1 becomes smaller with the passage of time, and the value becomes the size close to the specific target SOC (a) at time t2.

After completing the process of step S24A or S25, the ECU 12 proceeds to step S26 and determines whether the SOC of the battery 17 is equal to or higher than the EV-SW permission SOC.

In the vehicle control device 10 of the second embodiment described above, due to the low SOC control executed when it is determined Yes in step S22, the SOC of the battery 17 between time t1 and time t2 tends to be lower than the SOC of the battery 17 between time t1 and time t2 of the first embodiment. However, the EV-SW permission SOC (x) in this case is a value lower than the specific target SOC (c). Thus, even when the vehicle 11 executing the low SOC control travels on the specific traveling section RS in a state in which the target SOC set to the specific target SOC (c), the vehicle 11 is hardly prohibited from being put in the EV priority mode. That is, the vehicle 11 can execute the low SOC control, but is hardly hindered from traveling in the EV priority mode.

Further, in the second embodiment, the SOC value of the battery 17 when the vehicle 11 reaches the destination G tends to be smaller than the value of the SOC of the battery 17 when the vehicle 11 of the first embodiment reaches the destination G. Thus, in the second embodiment, the fuel efficiency of the vehicle 11 is more easily improved than the first embodiment.

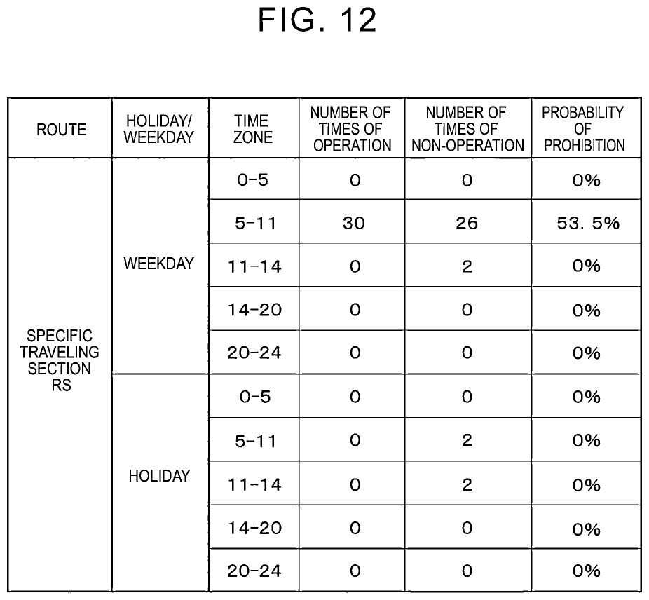

Hereinafter, a third embodiment of a vehicle control device 10 according to the present disclosure will be described with reference to FIGS. 12 to 14. The description of the technical contents in common with the first and second embodiments will be omitted.

The feature of the third embodiment is that the frequency determination unit 212 calculates the operation frequency instead of the prohibition frequency. The operation frequency is the frequency at which the EV switch was turned on when the vehicle 11 traveled in the specific traveling section RS in the past, the frequency being calculated by the frequency determination unit 212 based on the information on the place (location information) where the EV switch 18 is turned on and the date and time when the EV switch 18 is turned on, the information being included in the travel history information.

FIG. 12 shows an example of the operation frequency (travel history) when the vehicle 11 traveled on the specific traveling section RS in the past. More specifically, FIG. 12 shows the frequency at which the EV switch 18 is turned on, when the vehicle 11 that has executed the low SOC control while setting the target SOC of the battery 17 to the specific target SOC (a) travels on the specific traveling section RS. The data represented by FIG. 12 is recorded in the ROM of the external server 20. FIG. 12 shows that the vehicle 11 has traveled the specific traveling section RS 62 times in total in the past. For example, the EV switch 18 was turned on 30 times in total during the time zone between 5 o'clock and 11 o'clock on a weekday. In addition, the number of times the EV switch 18 was not turned on during the time zone between 5 o'clock and 11 o'clock on a weekday is 26 times in total. FIG. 12 shows that the EV switch 18 was turned on only 30 times while the vehicle 11 was traveling 56 times during the time zone between 5 o'clock and 11 o'clock on a weekday. That is, FIG. 12 shows that the EV switch 18 was turned on with a probability of 53.5% in the time zone between 5 o'clock and 11 o'clock on a weekday. The probability that the EV switch 18 is turned on in other time zones is 0%.

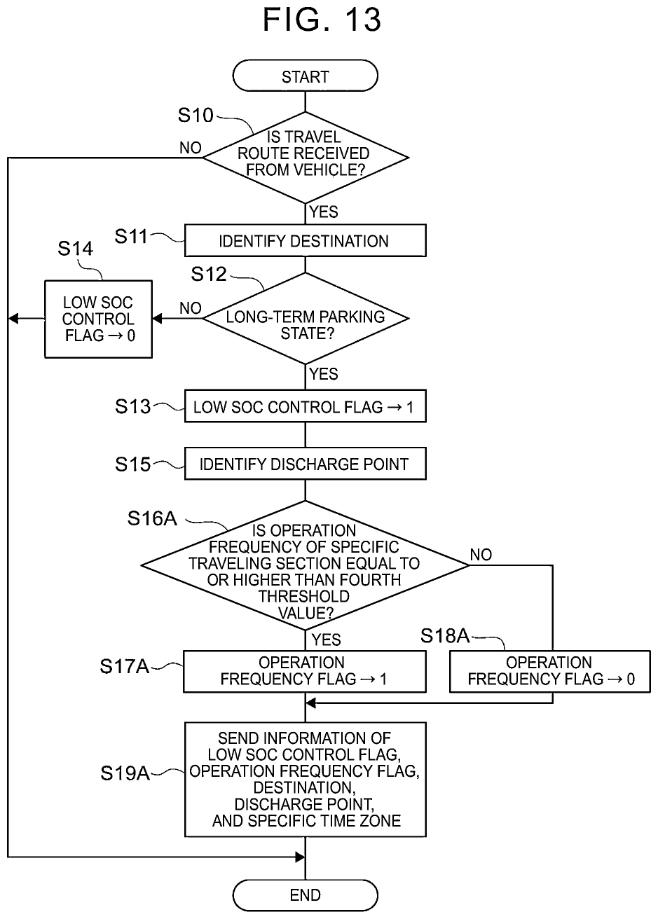

In the third embodiment, the external server 20 performs the process of the flowchart of FIG. 13. The flowchart of FIG. 13 differs from the flowchart of FIG. 7 only in steps S16A, S17A, S18A, and S19A.

In step S16A, the frequency determination unit 212 calculates the operation frequency at which the vehicle 11 has traveled on the specific traveling section RS in the past. Further, the frequency determination unit 212 determines whether the obtained operation frequency is equal to or higher than a predetermined fourth threshold value. The fourth threshold value of the present embodiment is 50%. However, the fourth threshold value may be a different value. When the current time is included in the time zone of 5-11 o'clock on a weekday, the frequency determination unit 212 determines Yes in step S16A and proceeds to step S17A.

The frequency determination unit 212 of the external server 20 that has proceeded to step S17A sets the value of the operation frequency flag to “1”. The initial value of the operation frequency flag is “0”.

When the external server 20 determines No in step S16A and proceeds to step S18A, the frequency determination unit 212 sets the value of the operation frequency flag to “0”.

The external server 20 that has completed the processes of steps S17A or S18A proceeds to step S19A. In step S19A, the wireless communication device 21 that is controlled by the communication control unit 213 wirelessly transmits to the vehicle 11 (wireless communication device 13), information on the low SOC control flag, the operation frequency flag, the predicted destination, the discharge point P, and the specific time zone that is a time zone in which the operation frequency is determines to be equal to or higher than the fourth threshold value.

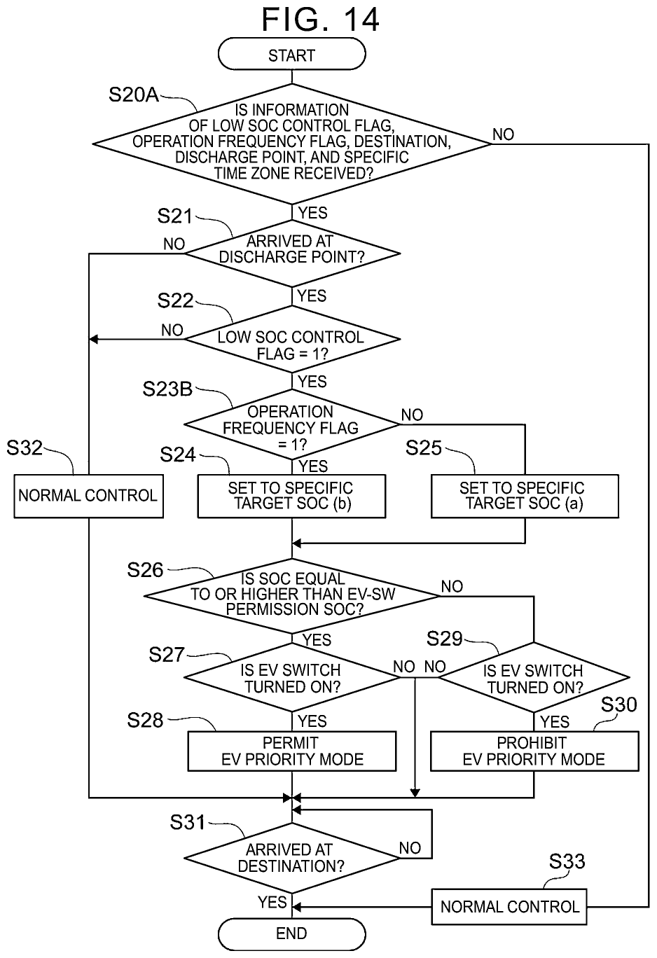

Further, in the third embodiment, the ECU 12 performs the process of the flowchart of FIG. 14. The flowchart of FIG. 14 differs from the flowchart of FIG. 8 only in steps S20A and S23B.

In step SS23B, the low SOC control unit 123 determines whether the value of the operation frequency flag is “1” and whether the current time is included in the specific time zone.

In the vehicle control device 10 of the third embodiment described above, the frequency determination unit 212 determines whether the operation frequency is equal to or higher than the fourth threshold value. Further, when the frequency determination unit 212 determines that the operation frequency is equal to or higher than the fourth threshold value and when the vehicle 11 travels on the specific traveling section RS, the EV-SW permission SOC is adjusted by the low SOC control unit 123 so that the specific target SOC is a value equal to or higher than the EV-SW permission SOC (specific target SOC (b)).

It is assumed that the operation frequency when the vehicle 11 that has executed the low SOC control while setting the target SOC of the battery 17 to the specific target SOC (a) travels on the specific traveling section RS is determined to be equal to or higher than the fourth threshold value. In this case, there is a high possibility that the EV switch 18 is turned on thereafter when the vehicle 11 travels in the specific traveling section RS in a state where the specific target SOC is lower than the EV-SW permission SOC. Thus, the frequency at which the vehicle 11 is prohibited from being put in the EV priority mode tends to increase. Therefore, in such a case, the low SOC control unit 123 adjusts the EV-SW permission SOC so that the specific target SOC becomes a value (specific target SOC (b)) that is equal to or higher than the EV-SW permission SOC. In this case, even when the vehicle 11 travels on the specific traveling section RS while executing the low SOC control, it is difficult to prohibit the vehicle 11 from being put in the EV priority mode. That is, the vehicle 11 can execute the low SOC control, but is hardly hindered from traveling in the EV priority mode.

Further, it is assumed that the operation frequency when the vehicle 11 has traveled in the specific traveling section RS in the past in a state in which the target SOC is lower than the EV-SW permission SOC is determined to be less than the fourth threshold value. In this case, there is a low possibility that the EV switch 18 is turned on thereafter when the vehicle 11 travels in the specific traveling section RS in a state where the specific target SOC is lower than the EV-SW permission SOC. Thus, the possibility that the frequency at which the vehicle 11 is prohibited from being put in the EV priority mode becomes high is low. In this case, even when the vehicle 11 executing the low SOC control travels on the specific traveling section RS in a state in which the specific target SOC is lower than the EV-SW permission SOC, the vehicle 11 is hardly prohibited from being put in the EV priority mode. That is, the vehicle 11 can execute the low SOC control, but is hardly hindered from traveling in the EV priority mode.

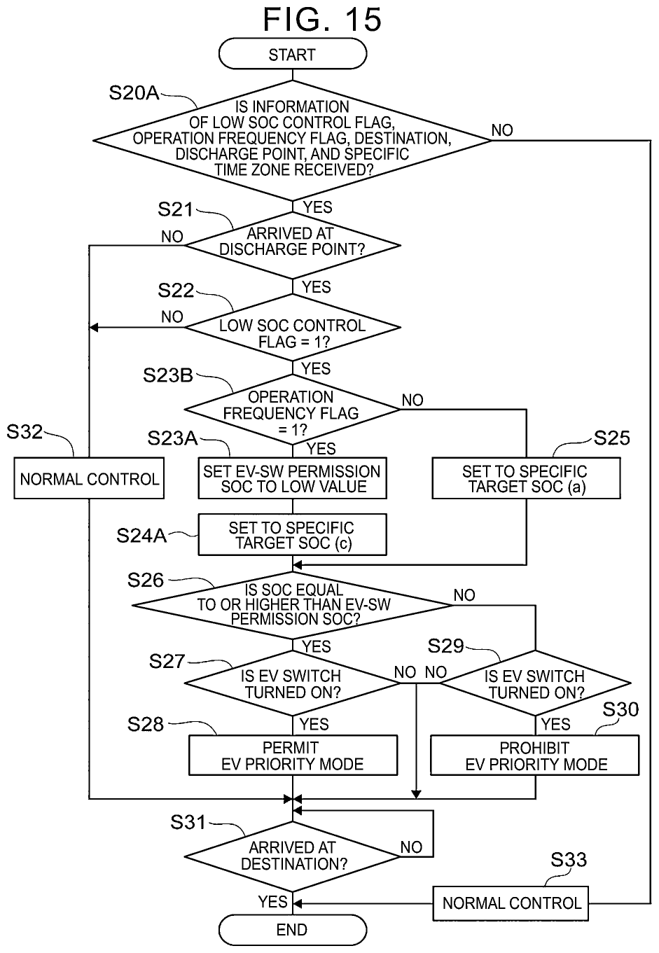

Hereinafter, a fourth embodiment of the vehicle control device 10 according to the present disclosure will be described with reference to FIG. 15. The description of the technical contents in common with the first to third embodiments will be omitted.

The disclosure of the fourth embodiment is a disclosure of a mode in which the second embodiment and the third embodiment are combined. In the fourth embodiment, the external server 20 performs the process of the flowchart of FIG. 13.

Further, in the fourth embodiment, the ECU 12 performs the process of the flowchart of FIG. 15. The flowchart of FIG. 15 differs from the flowchart of FIG. 14 only in steps S23A and S24A.

Thus, the disclosure of the fourth embodiment can exert the same effect as the disclosure of the third embodiment.

Further, similar to the second embodiment, the disclosure of the fourth embodiment easily improves the fuel efficiency of the vehicle 11 as compared with the first embodiment.

Although the vehicle control device 10 according to the first to fourth embodiments has been described above, the design of the vehicle control device 10 can be appropriately changed without departing from the scope of the present disclosure.

For example, the low SOC control unit 123 may execute the low SOC control based on the prohibition frequency and the operation frequency. That is, when the frequency determination unit 212 determines that the prohibition frequency is equal to or higher than the second threshold value and the operation frequency is equal to or higher than the fourth threshold value, and the vehicle 11 travels on the specific traveling section RS, the low SOC control unit 123 may adjust (change) at least one of the specific target SOC and the EV-SW permission SOC so that the specific target SOC becomes a value that is equal to or higher than the EV-SW permission SOC.

In the first to fourth embodiments, the external server 20 has the functions of the parking determination unit 211 and the frequency determination unit 212. However, the ECU 12 may have at least one function of the parking determination unit 211 and the frequency determination unit 212.

In the first to fourth embodiments, the ECU 12 has the function of the travel route prediction unit 121. However, the external server 20 may have the function of the travel route prediction unit 121. In this case, the information on the travel route estimated by the travel route prediction unit 121 of the external server 20 is wirelessly transmitted from the external server 20 to the vehicle 11.

When executing the low SOC control, the low SOC control unit 123 may adjust (change) at least one of the specific target SOC and the EV-SW permission SOC so that the specific target SOC and the EV-SW permission SOC become the same value.

When the travel history indicates that the vehicle 11 was parked at the destination G in the past for a time longer than the first threshold value for a number of times equal to or higher than the third threshold value, the parking determination unit 211 may determines that the vehicle 11 is in the long-term parking state. In this case, the parking determination unit 211 can determine with high accuracy whether the vehicle 11 will be in the long-term parking state. The third threshold value is, for example, 5 times.

Instead of the GPS receiver 14, the vehicle 11 may include a receiver capable of receiving information from satellites of a global navigation satellite system (for example, Galileo) other than the GPS.

What is claimed is:

1. A vehicle control device comprising:
an electric motor and an internal combustion engine that serve as a drive source of a vehicle;
a battery that is able to store electric power generated by the electric motor and that is able to supply the stored electric power to the electric motor;
a drive source control unit that puts the vehicle in an EV priority mode in which the electric motor is preferentially used as the drive source when an SOC that is a charge rate of the battery is equal to or higher than an EV-SW permission SOC that is lower than a normal target SOC of the battery and when an EV switch provided in the vehicle is turned on, and that prohibits the vehicle from being put in the EV priority mode when the SOC is less than the EV-SW permission SOC;
a parking determination unit that determines whether the vehicle is in a long-term parking state in which the vehicle is parked for a time longer than a first threshold value at a destination of a travel route that the vehicle is traveling, based on a travel history of the vehicle;
a low SOC control unit that executes a low SOC control in which a specific target SOC is set to a value lower than the normal target SOC when the parking determination unit determines that the vehicle is in the long-term parking state, the specific target SOC being a target SOC of the battery when the vehicle traveling from a predetermined location of the travel route toward the destination arrives at the destination; and
a frequency determination unit that determines whether a prohibition frequency at which the drive source control unit prohibits the vehicle from being put in the EV priority mode is equal to or higher than a second threshold value when the vehicle has traveled between the predetermined location and the destination in the past in a state in which the target SOC is set to a value lower than the EV-SW permission SOC,
wherein when the frequency determination unit determines that the prohibition frequency is equal to or higher than the second threshold value and when the vehicle travels between the predetermined location and the destination, the low SOC control unit adjusts at least one of the specific target SOC and the EV-SW permission SOC such that the specific target SOC becomes a value that is equal to or higher than the EV-SW permission SOC.

2. The vehicle control device according to claim 1, wherein when the travel history indicates that the vehicle was parked at the destination in the past for a time longer than the first threshold value for the number of times equal to or higher than a third threshold value, the parking determination unit determines that the vehicle is in the long-term parking state.

3. The vehicle control device according to claim 1, wherein when the low SOC control unit determines that the prohibition frequency is equal to or higher than the second threshold value, the low SOC control unit sets the specific target SOC to a value higher than the EV-SW permission SOC.

4. The vehicle control device according to claim 1, wherein when the low SOC control unit determines that the prohibition frequency is equal to or higher than the second threshold value, the low SOC control unit sets the EV-SW permission SOC to a value lower than the specific target SOC.

5. The vehicle control device according to claim 3, wherein when the low SOC control unit determines that the prohibition frequency is less than the second threshold value, the low SOC control unit sets the specific target SOC to a value lower than the EV-SW permission SOC.

6. The vehicle control device according to claim 1,
wherein when the vehicle has traveled between the predetermined location and the destination in the past in a state in which the specific target SOC is lower than the EV-SW permission SOC, the frequency determination unit determines whether an operation frequency at which the EV switch is turned on is equal to or higher than a fourth threshold value, and
wherein when the frequency determination unit determines that the prohibition frequency is equal to or higher than the second threshold value and that the operation frequency is equal to or higher than the fourth threshold value, and when the vehicle travels between the predetermined location and the destination, the low SOC control unit adjusts at least one of the specific target SOC and the EV-SW permission SOC such that the specific target SOC becomes a value that is equal to or higher than the EV-SW permission SOC.

7. A vehicle control device comprising:
an electric motor and an internal combustion engine that serve as a drive source of a vehicle;
a battery that is able to store electric power generated by the electric motor and that is able to supply the stored electric power to the electric motor;
a drive source control unit that puts the vehicle in an EV priority mode in which the electric motor is preferentially used as the drive source when an SOC that is a charge rate of the battery is equal to or higher than an EV-SW permission SOC that is lower than a normal target SOC of the battery and when an EV switch provided in the vehicle is turned on, and that prohibits the vehicle from being put in the EV priority mode when the SOC is less than the EV-SW permission SOC;
a parking determination unit that determines whether the vehicle is in a long-term parking state in which the vehicle is parked for a time longer than a first threshold value at a destination of a travel route that the vehicle is traveling, based on a travel history of the vehicle;
a low SOC control unit that executes a low SOC control in which a specific target SOC is set to a value lower than the normal target SOC when the parking determination unit determines that the vehicle is in the long-term parking state, the specific target SOC being a target SOC of the battery when the vehicle traveling from a predetermined location of the travel route toward the destination arrives at the destination; and
a frequency determination unit that determines whether an operation frequency at which the EV switch is turned on is equal to or higher than a fourth threshold value when the vehicle has traveled between the predetermined location and the destination in the past in a state in which the target SOC is set to a value lower than the EV-SW permission SOC,
wherein when the frequency determination unit determines that the operation frequency is equal to or higher than the fourth threshold value, and when the vehicle travels between the predetermined location and the destination, the low SOC control unit adjusts at least one of the specific target SOC and the EV-SW permission SOC such that the specific target SOC becomes a value that is equal to or higher than the EV-SW permission SOC.
